(19) United States
(12) Patent Application Publication
(10) Pub. No.: US 2006/0012491 A1
(43) Pub. Date: Jan. 19, 2006

(54) Utility meter reading system

(76) Inventor: Peter H. Mahowald, Los Altos, CA (US)

Correspondence Address: AGILENT TECHNOLOGIES, INC.;Legal Department, DL429, Intellectual Property Administration, P.O. Box 7599, Loveland, CO, 80537-0599, US

(21) Appl. No.: 10/890,907

(22) Filed: Jul. 14, 2004

(51) Int. Cl. G08C 15/06

(52) U.S. Cl. 340/870.02

(57) ABSTRACT

A meter reading system comprising a first sensor configured to obtain meter data from a first utility meter and transmit first signals of a first signal type on a first channel, a second sensor configured to receive the first signals on the first channel and transmit second signals of a second signal type on a second channel, and a first circuit. The first circuit configured to receive the second signals on the second channel and transmit third signals via radio frequency signals to a service provider.

### BACKGROUND

In a typical utility distribution system, a service provider distributes a resource to customers through a network of channels. Utility meters connected to the network of channels measure the amount of the resource, such as gas, water, or electricity, used by the customers. The customers include commercial customers and residential customers.

In gas and water distribution systems, gas and water channels include pipes connected to each utility meter in the system. In a power distribution system, distribution channels include wires connected to each utility meter in the system. Wires in the network can be run through conduit, such as wires run underground and inside buildings.

A utility meter is often placed at each customer's site to measure the amount of the resource used by the customer. The utility meter at a customer's site is read by the service provider to determine the amount of the resource used by the customer. The service provider, such as a gas utility, water utility or electric power utility, charges the customer based on the meter reading.

To obtain a meter reading, a service provider employee can observe a display on the utility meter or, in an automated system, an automated meter reader can obtain a meter reading from the utility meter and provide the meter reading to the service provider. In one system, each automated meter reader wirelessly transmits meter readings to a service provider employee driving along the street in a computer-equipped vehicle or walking past the customer's sites. With an automated meter reader installed at each customer's site, collecting meter readings can be accomplished much faster and more economically.

Automated meter readers are typically located next to the utility meters. If utility meters are located inside pits in the ground, wireless transmissions from automated meter readers may be absorbed by the soil and blocked. Also, if the pits are lined with concrete, wireless transmissions may be absorbed by the concrete and the soil, such that meter reading transmissions are blocked and unobtainable. In addition, pits are often covered and difficult to access for directly observing the displays on the utility meters.

For these and other reasons there is a need for the present invention.

### SUMMARY

One aspect of the present invention provides a meter reading system comprising a first sensor configured to obtain meter data from a first utility meter and transmit first signals of a first signal type on a first channel, a second sensor configured to receive the first signals on the first channel and transmit second signals of a second signal type on a second channel, and a first circuit. The first circuit configured to receive the second signals on the second channel and transmit third signals via radio frequency signals to a service provider.

### BRIEF DESCRIPTION OF THE DRAWINGS

FIG. 1 is a diagram illustrating one embodiment of a utility distribution system environment.

FIG. 2 is a diagram illustrating one embodiment of a utility meter reading system environment.

FIG. 3 is a flow chart diagram illustrating the operation of one embodiment of a utility meter reading system.

FIG. 4 is a flow chart diagram illustrating the operation of another embodiment of a utility meter reading system.

### DETAILED DESCRIPTION

In the following Detailed Description, reference is made to the accompanying drawings, which form a part hereof, and in which is shown by way of illustration specific embodiments in which the invention may be practiced. In this regard, directional terminology, such as “top,” “bottom,” “front,” “back,” “leading,” “trailing,” etc., is used with reference to the orientation of the Figure(s) being described. Because components of embodiments of the present invention can be positioned in a number of different orientations, the directional terminology is used for purposes of illustration and is in no way limiting. It is to be understood that other embodiments may be utilized and structural or logical changes may be made without departing from the scope of the present invention. The following Detailed Description, therefore, is not to be taken in a limiting sense, and the scope of the present invention is defined by the appended claims.

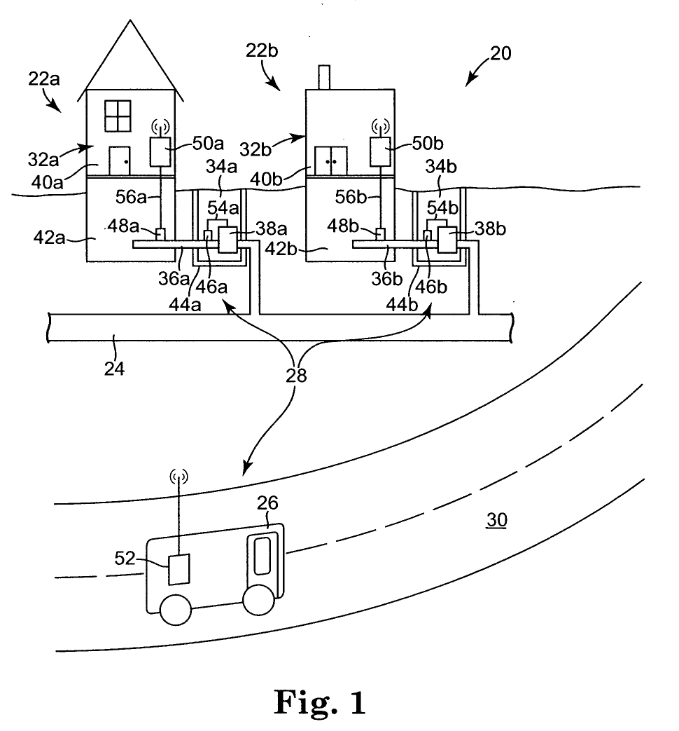

FIG. 1 is a diagram illustrating one embodiment of a utility distribution system environment 20. Utility distribution system environment 20 includes customer sites 22a and 22b, a resource distribution channel 24, a utility service provider vehicle 26, and a utility meter reading system, indicated at 28. Utility service provider vehicle 26 travels on a road 30 past customer sites 22a and 22b.

Customer site 22a includes a residential building 32a, a utility meter pit 34a, a customer site resource distribution channel 36a, and a utility meter 38a. Residential building 32a includes a first floor 40a and a ground floor or basement 42a. Utility meter pit 34a includes a concrete floor and walls, indicated at 44a. Customer site resource distribution channel 36a extends from utility meter pit 34a into basement 42a and throughout residential building 32a. Utility meter 38a is located in utility meter pit 34a and coupled to resource distribution channel 24 and customer site resource distribution channel 36a.

Customer site 22b includes a commercial building 32b, a utility meter pit 34b, a customer site resource distribution channel 36b, and a utility meter 38b. Commercial building 32b includes a first floor 40b and a ground floor or basement 42b. Utility meter pit 34b includes a concrete floor and walls, indicated at 44b. Customer site resource distribution channel 36b extends from utility meter pit 34b into basement 42b and throughout commercial building 32b. Utility meter 38b is located in utility meter pit 34b and coupled to resource distribution channel 24 and customer site resource distribution channel 36b.

Resource distribution channel 24, customer site resource distribution channels 36a and 36b, and utility meters 38a and 38b are part of a utility distribution system, such as a gas distribution system, a water distribution system, or a power distribution system. Resource distribution channel 24 delivers a resource provided by the utility distribution system to customer sites 22a and 22b. The resource flows from resource distribution channel 24 to customer site resource distribution channel 36a and into residential building 32a, where the resource is used by the customer. The resource flows from resource distribution channel 24 to customer site resource distribution channel 36b and into commercial building 32b, where the resource is used by the customer.

Utility meters 38a and 38b are coupled to resource distribution channel 24 and customer site resource distribution channels 36a and 36b to measure the amount of the resource provided to customer sites 22a and 22b. Utility meter 38a is coupled to resource distribution channel 24 and customer site resource distribution channel 36a to measure the amount of the resource provided to customer site 22a. Utility meter 38b is coupled to resource distribution channel 24 and customer site resource distribution channel 36b to measure the amount of the resource provided to customer site 22b.

In a gas distribution system, resource distribution channel 24 and customer site resource distribution channels 36a and 36b are gas pipes. Utility meters 38a and 38b are gas meters fluidically coupled to resource distribution channel 24. Utility meter 38a is fluidically coupled to resource distribution channel 24 and customer site resource distribution channel 36a to measure the amount of gas provided to customer site 22a. Utility meter 38b is fluidically coupled to resource distribution channel 24 and customer site resource distribution channel 36b to measure the amount of gas provided to customer site 22b. The gas distribution system is operated by a service provider, such as a gas utility, to provide gas to customer sites 22a and 22b through resource distribution channel 24.

In a water distribution system, resource distribution channel 24 and customer site resource distribution channels 36a and 36b are water pipes. Utility meters 38a and 38b are water meters fluidically coupled to resource distribution channel 24. Utility meter 38a is fluidically coupled to resource distribution channel 24 and customer site resource distribution channel 36a to measure the amount of water provided to customer site 22a. Utility meter 38b is fluidically coupled to resource distribution channel 24 and customer site resource distribution channel 36b to measure the amount of water provided to customer site 22b. The water distribution system is operated by a service provider, such as a water utility, to provide water to customer sites 22a and 22b through resource distribution channel 24.

In a power distribution system, resource distribution channel 24 includes conductive wires and customer site resource distribution channels 36a and 36b include conductive wires in conduit. Utility meters 38a and 38b are electric power meters electrically coupled to wires in resource distribution channel 24. Utility meter 38a is electrically coupled to wires in resource distribution channel 24 and wires in customer site resource distribution channel 36a to measure the amount of electricity provided to customer site 22a. Utility meter 38b is electrically coupled to wires in resource distribution channel 24 and wires in customer site resource distribution channel 36b to measure the amount of electricity provided to customer site 22b. The power distribution system is operated by a service provider, such as an electric power utility, to provide electricity to customer sites 22a and 22b through the wires in resource distribution channel 24.

In one embodiment, utility meter reading system 28 includes meter reading sensors 46a and 46b, dual channel sensors 48a and 48b, customer site wireless circuits 50a and 50b, and service provider wireless circuit 52. Utility meter reading system 28 obtains resource usage data from customer sites 22a and 22b and provides the resource usage data to the utility service provider. Customer site wireless circuits 50a and 50b wirelessly transmit resource usage data from customer sites 22a and 22b, respectively, to service provider wireless circuit 52. In one embodiment, customer site wireless circuits 50a and 50b are in bi-directional communication with service provider wireless circuit 52. In one embodiment, customer site wireless circuits 50a and 50b communicate with service provider wireless circuit 52 via radio frequency signals.

Meter reading sensors 46a and 46b obtain meter readings or meter reading data from utility meters 38a and 38b. In one embodiment, meter reading sensor 46a is electrically coupled to utility meter 38a via meter reading conductive path 54a, and meter reading sensor 46b is electrically coupled to utility meter 38b via meter reading conductive path 54b. Meter reading sensor 46a obtains meter reading data from utility meter 38a via conductive path 54a, and meter reading sensor 46b obtains meter reading data from utility meter 38b via conductive path 54b. In one embodiment, meter reading sensor 46a is in bi-directional communication with utility meter 38a, and meter reading sensor 46b is in bi-directional communication with utility meter 38b. In other embodiments, meter reading sensors 46a and 46b obtain meter reading data from utility meters 38a and 38b in any suitable manner, such as wireless radio frequency transmissions or imaging of displays on utility meters 38a and 38b. In one embodiment, meter reading sensor 46a includes an image sensor that acquires an image of the display on utility meter 38a, and meter reading sensor 46b includes an image sensor that acquires an image of the display on utility meter 38b.

Meter reading sensors 46a and 46b process meter reading data and transmit meter reading signals to dual channel sensors 48a and 48b. In one embodiment, meter reading sensor 46a is communicatively coupled to customer site distribution channel 36a to transmit meter reading signals via sonic signals. Also, meter reading sensor 46b is communicatively coupled to customer site distribution channel 36b to transmit meter reading signals via sonic signals. Customer site distribution channels 36a and 36b include any suitable distribution channel material, such as gas pipes in a gas distribution system, water pipes in a water distribution system, and conduit in a power distribution system. The sonic signals can be any suitable sonic signals. In one embodiment, the sonic signals are in the hearing frequency range, such as 20 Hz-20 KHz. In one embodiment, the sonic signals are in the ultrasonic frequency range, such as greater than 20 KHz. In one embodiment, the sonic signals are amplitude modulated signals. In one embodiment, the sonic signals are frequency modulated signals.

Dual channel sensors 48a and 48b receive the meter reading signals from meter reading sensors 46a and 46b, respectively. Dual channel sensors 48a and 48b process the received meter reading signals and transmit sensor signals to customer site wireless circuits 50a and 50b. In one embodiment, dual channel sensor 48a is communicatively coupled to customer site distribution channel 36a to receive meter reading signals via sonic signals from meter reading sensor 46a. Also, dual channel sensor 48b is communicatively coupled to customer site distribution channel 36b to receive meter reading signals via sonic signals from meter reading sensor 46b.

In one embodiment, meter reading sensors 46a and 46b are in bi-directional communication with dual channel sensors 48a and 48b via customer site distribution channels 36a and 36b. Meter reading sensor 46a is in bi-directional communication with dual channel sensor 48a via customer site distribution channel 36a, and meter reading sensor 46b is in bi-directional communication with dual channel sensor 48b via customer site distribution channel 36b. In one embodiment, meter reading sensors 46a and 46b communicate with dual channel sensors 48a and 48b via other supplied channels, such as pipes or metal bars run in parallel with customer site distribution channels 36a and 36b.

Dual channel sensors 48a and 48b transmit sensor signals to customer site wireless circuits 50a and 50b. In one embodiment, dual channel sensor 48a is electrically coupled to customer site wireless circuit 50a via conductive path 56a, and dual channel sensor 48b is electrically coupled to customer site wireless circuit 50b via conductive path 56b. Dual channel sensor 48a transmits sensor signals to customer site wireless circuit 50a via conductive path 56a, and dual channel sensor 48b transmits sensor signals to customer site wireless circuit 50b via conductive path 56b. In other embodiments, dual channel sensors 48a and 48 communicate with customer site wireless circuits 50a and 50b in any suitable manner, such as wireless radio frequency transmissions.

In one embodiment, dual channels sensors 48a and 48b are in bi-directional communication with customer site wireless circuits 50a and 50b via conductive paths 56a and 56b. Dual channel sensor 48a is in bi-directional communication with customer site wireless circuit 50a via conductive path 56a. Dual channel sensor 48b is in bi-directional communication with customer site wireless circuit 50b via conductive path 56b.

Customer site wireless circuits 50a and 50b receive the sensor signals from dual channels sensors 48a and 48b, respectively. Customer site wireless circuits 50a and 50b process the sensor signals and provide resource usage data to service provider wireless circuit 52. In one embodiment, customer site wireless circuit 50a is located on the first floor 40a of residential building 32a to communicate with service provider wireless circuit 52 via radio frequency signals. Also, customer site wireless circuit 50b is located on the first floor 40b of commercial building 32b to communicate with service provider wireless circuit 52 via radio frequency signals.

In one embodiment, service provider wireless circuit 52 is located in service provider vehicle 26. As service provider vehicle 26 travels past customer sites 22a and 22b on road 30, service provider wireless circuit 52 requests resource usage data from customer sites 22a and 22b. Customer site wireless circuits 50a and 50b receive the request and provide resource usage data from customer sites 22a and 22b. Customer site wireless circuit 50a transmits resource usage data from customer site 22a and customer site wireless circuit 50b transmits resource usage data from customer site 22b.

In other embodiments, service provider wireless circuit 52 is located on any suitable mobile or non-mobile platform to retrieve resource usage data from customer sites 22a and 22b. In one embodiment, service provider wireless circuit 52 is part of a hand held device that is carried by a service provider employee past customer sites 22a and 22b to retrieve resource usage data. In one embodiment, service provider wireless circuit 52 is mounted to a tower located within range of receiving radio frequency transmissions from customer site wireless circuits 50a and 50b to receive resource usage data. In one tower embodiment, customer sites 22a and 22b are programmed to provide resource usage data at periodic intervals to service provider wireless circuit 52 located on the tower.

In operation of one embodiment including bi-directional communications, service provider wireless circuit 52 transmits a meter reading request for resource usage data from one or both customer sites 22a and 22b. The request from service provider circuit 52 is transmitted via radio frequency signals. Customer site wireless circuit 50a receives the request and transmits a meter reading request signal to dual channel sensor 48a via conductive path 56a, and customer site wireless circuit 50b receives the request and transmits a meter reading request signal to dual channel sensor 48b via conductive path 56b.

Dual channel sensors 48a and 48b receive the request signals and transmit meter reading request signals to meter reading sensors 46a and 46b. The meter reading request signals are transmitted via sonic signals. Dual channel sensor 48a receives a request signal and transmits a meter reading request signal to meter reading sensor 46a via customer site resource distribution channel 36a. The meter reading request signal is transmitted via sonic signals that travel from residential building 32a to utility meter pit 34a along and through customer site distribution channel 36a. Dual channel sensor 48b receives a request signal and transmits a meter reading request signal to meter reading sensor 46b via customer site resource distribution channel 36b. The meter reading request signal is transmitted via sonic signals that travel from commercial building 32b to utility meter pit 34b along and through customer site resource distribution channel 36b.

Meter reading sensors 46a and 46b receive the meter reading request signals and in response provide meter reading data from utility meters 38a and 38b, respectively. Meter reading sensor 46a processes the meter reading data from utility meter 38a and provides meter reading signals to dual channel sensor 48a via customer site distribution channel 36a. The meter reading signals are transmitted as sonic signals that travel from utility meter pit 34a to residential building 32a via customer site distribution channel 36a. Meter reading sensor 46b processes the meter reading data from utility meter 38b and provides meter reading signals to dual channel sensor 48b via customer site distribution channel 36b. The meter reading signals are transmitted as sonic signals that travel from utility meter pit 34b to commercial building 32b via customer site distribution channel 36b.

Dual channel sensor 48a processes the received meter reading signals and provides sensor signals to customer site wireless circuit 50a, and dual channel sensor 48b processes the received meter reading signals and provides sensor signals to customer site wireless circuit 50b. Customer site wireless circuits 50a and 50b transmit resource usage data to service provide wireless circuit 52 via radio frequency signals.

In operation of another embodiment, meter reading sensors 46a and 46b obtain meter reading data from utility meters 38a and 38b, respectively, and periodically provide the meter reading data to the utility service provider. Meter reading sensor 46a processes the meter reading data from utility meter 38a and provides meter reading signals to dual channel sensor 48a. The meter reading signals are sonic signals that travel from utility meter pit 34a to residential building 32a via customer site distribution channel 36a. Meter reading sensor 46b processes the meter reading data from utility meter 38b and provides meter reading signals to dual channel sensor 48b. The meter reading signals are sonic signals that travel from utility meter pit 34b to commercial building 32b via customer site distribution channel 36b.

Dual channel sensor 48a processes the received meter reading signals and provides sensor signals to customer site wireless circuit 50a, and dual channel sensor 48b processes the received meter reading signals and provides sensor signals to customer site wireless circuit 50b. Customer site wireless circuits 50a and 50b periodically transmit resource usage data to a service provider wireless circuit, such as a service provider wireless circuit located in a tower, via radio frequency signals.

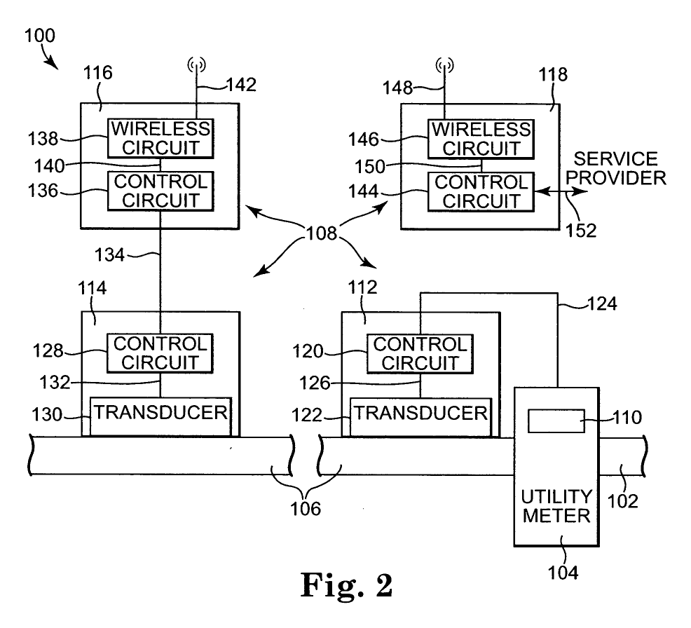

FIG. 2 is a diagram illustrating one embodiment of a utility meter reading system environment 100. Utility meter reading system environment 100 includes a resource distribution channel 102, a utility meter 104, a customer site resource distribution channel 106, and a utility meter reading system, indicated at 108. Utility meter reading system environment 100 is similar to utility distribution system environment 20 of FIG. 1.

Utility meter 104 is coupled to resource distribution channel 102 and to customer site resource distribution channel 106 to measure the amount of a resource provided to a customer's site. Resource distribution channel 102 supplies a resource from a utility distribution system to utility meter 104. Resource distribution channel 102 is similar to resource distribution channel 24 (shown in FIG. 1). Utility meter 104 measures the amount of the resource provided through resource distribution channel 102 to customer site resource distribution channel 106. Utility meter 104 is similar to each of the utility meters 38a and 38b (shown in FIG. 1). Utility meter 104 includes a display 110 that displays the amount of the resource provided to a customer's site via customer site resource distribution channel 106.

Customer site resource distribution channel 106 receives the resource from resource distribution channel 102 via utility meter 104. Customer site resource distribution channel 106 provides the resource to a customer's site and is similar to each of the customer site resource distribution channels 36a and 36b (shown in FIG. 1). Resource distribution channel 102, utility meter 104, and customer site resource distribution channel 106 are part of a utility distribution system, such as a gas distribution system, a water distribution system, or a power distribution system.

In a gas distribution system, resource distribution channel 102 and customer site resource distribution channel 106 are gas pipes. Utility meter 104 is a gas meter fluidically coupled to resource distribution channel 102 and to customer site resource distribution channel 106 to measure the amount of gas provided to a customer's site via customer site resource distribution channel 106. The gas distribution system is operated by a service provider, such as a gas utility, to provide gas to customer sites through resource distribution channel 102.

In a water distribution system, resource distribution channel 102 and customer site resource distribution channel 106 are water pipes. Utility meter 104 is a water meter fluidically coupled to resource distribution channel 102 and to customer site resource distribution channel 106 to measure the amount of water provided to the customer's site via customer site resource distribution channel 106. The water distribution system is operated by a service provider, such as a water utility, to provide water to customer sites through resource distribution channel 102.

In a power distribution system, resource distribution channel 102 includes conductive wires and customer site resource distribution channel 106 includes conductive wires in conduit. Utility meter 104 is an electric power meter electrically coupled to wires in resource distribution channel 102 and to wires in customer site resource distribution channel 106 to measure the amount of electricity provided to customer site via customer site resource distribution channel 106. The power distribution system is operated by a service provider, such as an electric power utility, to provide electricity to customer sites through the wires in resource distribution channel 102.

In one embodiment, utility meter reading system 108 includes meter reading sensor 112, dual channel sensor 114, customer site wireless circuit 116, and service provider wireless circuit 118. Utility meter reading system 108 is similar to utility meter reading system 28 (shown in FIG. 1). Utility meter reading system 108 obtains meter reading data from utility meter 104 and provides resource usage data to the utility service provider.

Meter reading sensor 112 includes a meter reading control circuit 120 and a meter reading sensor transducer 122. Meter reading control circuit 120 is electrically coupled to utility meter 104 via conductive path 124 and to meter reading sensor transducer 122 via conductive path 126. Meter reading sensor transducer 122 is communicatively coupled to customer site resource distribution channel 106. Meter reading sensor 112 is similar to each of the meter reading sensors 46a and 46b (shown in FIG. 1). Meter reading sensor 112 obtains meter readings or meter reading data from utility meter 104, processes the meter reading data, and transmits meter reading signals to dual channel sensor 114.

Dual channel sensor 114 includes a dual channel control circuit 128 and a dual channel sensor transducer 130. Dual channel sensor transducer 130 is communicatively coupled to customer site resource distribution channel 106. Dual channel control circuit 128 is electrically coupled to dual channel sensor transducer 130 via conductive path 132 and to customer site wireless circuit 116 via conductive path 134. Dual channel sensor 114 is similar to each of the dual channel sensors 48a and 48b (shown in FIG. 1). Dual channel sensor 114 receives meter reading signals from meter reading sensor 112, processes the received meter reading signals, and transmits sensor signals to customer site wireless circuit 116.

Customer site wireless circuit 116 includes a control circuit 136 and a wireless circuit 138. Control circuit 136 is electrically coupled to dual channel control circuit 128 via conductive path 134 and to wireless circuit 138 via conductive path 140. Also, wireless circuit 138 is electrically coupled to antenna 142. Customer site wireless circuit 116 is similar to each of the customer site wireless circuits 50a and 50b (shown in FIG. 1). Customer site wireless circuit 116 receives sensor signals from dual channels sensor 114, processes received sensor signals, and provides resource usage data to service provider wireless circuit 118 via wireless signals.

Service provider wireless circuit 118 includes a control circuit 144 and a wireless circuit 146. Wireless circuit 146 is electrically coupled to antenna 148. Control circuit 144 is electrically coupled to wireless circuit 146 via conductive path 150, and control circuit 144 is in communication with the service provider at 152. Service provider wireless circuit 118 is similar to service provider wireless circuit 52 (shown in FIG. 1). Service provider wireless circuit 118 receives resource usage data via wireless signals from customer site wireless circuit 116 and provides the resource usage data to the service provider at 152. The resource usage data indicates the amount of the resource used as measured by utility meter 104 and obtained by meter reading sensor 112.

In meter reading sensor 112, meter reading control circuit 120 obtains meter reading data from utility meter 104 via conductive path 124. In one embodiment, meter reading control circuit 120 receives electrical pulses from utility meter 104. The electrical pulses represent the amount of the resource flowing into customer site resource distribution channel 106. In one embodiment, meter reading control circuit 120 compiles the electrical pulses to obtain a compiled meter reading value. The compiled meter reading value can be any suitable value, such as an accumulated value that is not reset at each meter reading or an accumulated value that is reset at each meter reading.

In one embodiment, meter reading control circuit 120 receives a compiled meter reading value directly from utility meter 104. In one embodiment, the compiled meter reading value is transmitted periodically from utility meter 104 to meter reading control circuit 120. In one embodiment, meter reading control circuit 120 communicates bi-directionally with utility meter 104 to request the compiled meter reading value from utility meter 104, which responds with the compiled meter reading value. In any embodiment, the compiled meter reading value can be any suitable meter reading value, such as an accumulated value that is not reset at each meter reading or an accumulated value that is reset at each meter reading.

Meter reading control circuit 120 transmits electrical signals to meter reading sensor transducer 122 via conductive path 126. Meter reading sensor transducer 122 converts the electrical signals to sonic signals. The sonic signals are communicated to dual channel sensor 114 via customer site resource distribution channel 106.

In one embodiment, meter reading control circuit 120 transmits an electrical signal for each electrical pulse received from utility meter 104. The electrical signal is received by meter reading sensor transducer 122, which transmits a corresponding sonic meter reading signal to dual channel sensor 114. In one embodiment, meter reading control circuit 120 transmits electrical signals that represent a compiled meter reading value. The electrical signals are received by meter reading sensor transducer 122, which transmits corresponding sonic meter reading signals to dual channel sensor 114. In one embodiment, meter reading control circuit 120 transmits electrical signals that represent the compiled meter reading value transmitted periodically by utility meter 104. In one embodiment, meter reading control circuit 120 periodically transmits electrical signals that represent a meter reading value compiled by meter reading control circuit 120.

In one embodiment, meter reading control circuit 120 communicates bi-directionally with dual channel sensor 114. Meter reading sensor transducer 122 receives sonic signals from dual channel sensor 114 via customer site resource distribution channel 106. Meter reading sensor transducer 122 converts the received sonic signals to electrical signals that are transmitted to meter reading control circuit 120.

In one embodiment, dual channel sensor 114 transmits a sonic meter reading request signal to meter reading sensor transducer 122 that transmits a corresponding electrical meter reading request signal to meter reading control circuit 120. Meter reading control circuit 120 responds to the request by transmitting a compiled meter reading value to meter reading sensor transducer 122, which transmits corresponding sonic meter reading signals to dual channel sensor 114. In one embodiment, the compiled meter reading value is compiled by utility meter 104 and retrieved from utility meter 104 via a meter reading request signal. In one embodiment, the compiled meter reading value is compiled by control circuit 120. In one embodiment, signals received from dual channel sensor 114 include any suitable control signals, such as signals for closing valves coupled to meter reading control circuit 120.

In dual channel sensor 114, dual channel sensor transducer 130 receives sonic signals, such as sonic meter reading signals, from meter reading sensor transducer 122 via customer site resource distribution channel 106. Dual channel sensor transducer 130 converts the received sonic signals to electrical signals that are transmitted to dual channel control circuit 128 via conductive path 132. Dual channel control circuit 128 receives the electrical signals from dual channel sensor transducer 130 and provides sensor signals to customer site wireless circuit 116 via conductive path 134.

In one embodiment, dual channel sensor transducer 130 receives sonic meter reading signals that represent the electrical pulses from utility meter 104. Dual channel sensor transducer 130 converts the sonic signals to electrical signals that are provided to dual channel control circuit 128. In one embodiment, dual channel control circuit 128 compiles the electrical signals to obtain a compiled meter reading value. The compiled meter reading value can be any suitable value, such as an accumulated value that is not reset at each meter reading or an accumulated value that is reset at each meter reading.

In one embodiment, dual channel sensor transducer 130 receives sonic meter reading signals that represent a compiled meter reading value. In one embodiment, the compiled meter reading value is compiled by utility meter 104 and transmitted periodically from utility meter 104. In one embodiment, the compiled meter reading value is compiled by meter reading control circuit 120 and transmitted periodically.

In one embodiment, dual channel sensor transducer 130 and dual channel control circuit 128 communicate bi-directionally with meter reading sensor 112 to request the compiled meter reading value. In bi-directional communication, dual channel control circuit 128 provides electrical signals to dual channel sensor transducer 130 via conductive path 132. Dual channel sensor transducer 130 converts the electrical signals to sonic signals that are transmitted to meter reading sensor transducer 122 via customer site resource distribution channel 106.

In one embodiment, dual channel control circuit 128 provides an electrical meter reading request signal to dual channel sensor transducer 130. Dual channel sensor transducer 130 converts the electrical meter reading request signal to a sonic meter reading request signal that is transmitted to meter reading sensor transducer 122. Meter reading sensor 112 responds with a compiled meter reading value. In one embodiment, the compiled meter reading value is compiled by utility meter 104 and retrieved from utility meter 104 via a meter reading request signal. In one embodiment, the compiled meter reading value is compiled by meter reading control circuit 120. In one embodiment, signals transmitted by dual channel sensor 114 to meter reading sensor 112 include any suitable control signals, such as signals for closing valves coupled to meter reading control circuit 120.

Dual channel control circuit 128 transmits electrical sensor signals to customer site wireless circuit 116 via conductive path 134. In one embodiment, dual channel control circuit 128 transmits sensor signals that represent the electrical pulses transmitted from utility meter 104. In one embodiment, dual channel control circuit 120 transmits sensor signals that represent a compiled meter reading value.

The compiled meter reading value can be any suitable compiled meter reading value. In one embodiment, dual channel control circuit 128 transmits sensor signals that represent the compiled meter reading value transmitted periodically by utility meter 104. In one embodiment, dual channel control circuit 128 transmits sensor signals that represent the compiled meter reading value compiled by meter reading sensor 112 and transmitted periodically. In one embodiment, dual channel control circuit 128 periodically transmits sensor signals that represent a meter reading value compiled by the dual channel control circuit 128.

In one embodiment, dual channel control circuit 128 communicates bi-directionally with customer site wireless circuit 116. Customer site wireless circuit 116 transmits a meter reading request signal to dual channel control circuit 128. Dual channel control circuit 128 transmits a compiled meter reading value to customer site wireless circuit 116 in response to the request. In one embodiment, the compiled meter reading value was compiled by utility meter 104. In one embodiment, the compiled meter reading value was compiled by meter reading control circuit 120. In one embodiment, the compiled meter reading value was compiled by dual channel control circuit 128. In one embodiment, signals transmitted by customer site wireless circuit 116 to dual channel sensor 114 include any suitable control signals, such as signals for closing valves coupled to meter reading control circuit 120.

In customer site wireless circuit 116, control circuit 136 receives sensor signals from dual channel control circuit 128 via conductive path 134. Control circuit 136 processes the sensor signals and transmits signals to wireless circuit 138 via conductive path 140. Wireless circuit 138 receives the signals and transmits corresponding wireless signals via antenna 142. The wireless signals are received by service provider wireless circuit 118. In one embodiment, the wireless signals include resource usage data that is provided to the service provider. In one embodiment, the wireless signals are radio frequency signals.

In one embodiment, control circuit 136 receives sensor signals that represent the electrical pulses from utility meter 104. Control circuit 136 compiles the electrical pulse sensor signals to obtain a compiled meter reading value. The compiled meter reading value can be any suitable value, such as an accumulated value that is not reset at each meter reading or an accumulated value that is reset at each meter reading.

In one embodiment, control circuit 136 receives sensor signals that represent a compiled meter reading value. In one embodiment, the compiled meter reading value is compiled by utility meter 104 and transmitted periodically from utility meter 104. In one embodiment, the compiled meter reading value is compiled by meter reading control circuit 120 and transmitted periodically. In one embodiment, the compiled meter reading value is compiled by dual channel control circuit 128 and transmitted periodically.

In one embodiment, control circuit 136 communicates bi-directionally with dual channel control circuit 128 to request the compiled meter reading value. In bi-directional communication, control circuit 136 transmits signals to dual channel control circuit 128 via conductive path 134. In one embodiment, control circuit 136 provides a meter reading request signal to dual channel control circuit 128. In response, dual channel control circuit 128 transmits sensor signals that represent a compiled meter reading value to control circuit 136. In one embodiment, the compiled meter reading value is compiled by utility meter 104 and retrieved from utility meter 104 via a meter reading request signal. In one embodiment, the compiled meter reading value is compiled by meter reading control circuit 120 and retrieved from meter reading control circuit 120 via a meter reading request signal. In one embodiment, the compiled meter reading value is compiled by dual channel control circuit 128. In one embodiment, signals transmitted by customer site wireless circuit 116 to dual channel sensor 114 include any suitable control signals, such as signals for closing valves coupled to meter reading control circuit 120.

Customer site wireless circuit 116 transmits wireless signals to service provider wireless circuit 118. In wireless communications, control circuit 136 transmits signals to wireless circuit 138, which transmits corresponding wireless signals via antenna 142 to service provider wireless circuit 118. Control circuit 136 and wireless circuit 138 transmit wireless signals that represent resource usage data including a compiled meter reading value.

The compiled meter reading value can be any suitable compiled meter reading value. In one embodiment, control circuit 136 and wireless circuit 138 transmit wireless signals that represent the compiled meter reading value transmitted periodically by utility meter 104. In one embodiment, control circuit 136 and wireless circuit 138 transmit wireless signals that represent the compiled meter reading value compiled by meter reading control circuit 120 and transmitted periodically. In one embodiment, control circuit 136 and wireless circuit 138 transmit wireless signals that represent the compiled meter reading value compiled by dual channel control circuit 128 and transmitted periodically. In one embodiment, control circuit 136 and wireless circuit 138 periodically transmit wireless signals that represent a meter reading value compiled by control circuit 136.

In one embodiment, wireless circuit 138 is a transceiver and control circuit 136 and wireless circuit 138 communicate bi-directionally with service provider wireless circuit 118. Service provider wireless circuit 118 transmits a meter reading request signal to wireless circuit 138. Wireless circuit 138 receives the meter reading request signal via antenna 142 and transmits a corresponding meter reading request signal to control circuit 136 via conductive path 140. Control circuit 136 transmits resource usage data including a compiled meter reading value to service provider wireless circuit 118 in response to the meter reading request signal.

In one embodiment, the compiled meter reading value is the value compiled by utility meter 104 and retrieved via a meter reading request signal. In one embodiment, the compiled meter reading value is the value compiled by meter reading control circuit 120 and retrieved via a meter reading request signal. In one embodiment, the compiled meter reading value is the value compiled by dual channel control circuit 128 and retrieved via a meter reading request signal. In one embodiment, the compiled meter reading value is the value compiled by control circuit 136. In one embodiment, signals transmitted by service provider wireless circuit 118 to customer site wireless circuit 116 include any suitable control signals, such as signals for closing valves coupled to meter reading control circuit 120.

In service provider wireless circuit 118, wireless circuit 146 receives wireless signals via antenna 148 and transmits corresponding signals to control circuit 144 via conductive path 150. Control circuit 144 transmits signals to the service provider at 152. Wireless circuit 146 receives wireless signals via antenna 148 from wireless circuits, such as wireless circuit 138 in customer site wireless circuit 116. In one embodiment, the wireless signals include resource usage data that is provided to the service provider. In one embodiment, the wireless signals are radio frequency signals.

Service provider wireless circuit 118 receives wireless signals that represent resource usage data including a compiled meter reading value. In one embodiment, the compiled meter reading value is the value compiled by utility meter 104 and transmitted periodically from utility meter 104. In one embodiment, the compiled meter reading value is the value compiled by meter reading control circuit 120 and transmitted periodically. In one embodiment, the compiled meter reading value is the value compiled by dual channel control circuit 128 and transmitted periodically. In one embodiment, the compiled meter reading value is the value compiled by control circuit 136 and transmitted periodically.

In one embodiment, wireless circuit 146 is a transceiver and wireless circuit 146 and control circuit 144 communicate bi-directionally with customer site wireless circuit 116 to request the compiled meter reading value. In bi-directional communications, control circuit 144 transmits signals to wireless circuit 146 via conductive path 150. Wireless circuit 146 receives the signals and transmits corresponding wireless signals to customer site wireless circuit 116.

In one embodiment, control circuit 144 provides a meter reading request signal to wireless circuit 146, which transmits a wireless meter reading request signal to customer site wireless circuit 116. In response, customer site wireless circuit 116 transmits wireless signals that represent a compiled meter reading value to wireless circuit 146 and control circuit 144.

In one embodiment, the compiled meter reading value is compiled by utility meter 104 and retrieved from utility meter 104 via a meter reading request signal. In one embodiment, the compiled meter reading value is compiled by meter reading control circuit 120 and retrieved from meter reading control circuit 120 via a meter reading request signal. In one embodiment, the compiled meter reading value is compiled by dual channel control circuit 128 and retrieved from dual channel control circuit 128 via a meter reading request signal. In one embodiment, the compiled meter reading value is compiled by control circuit 136. In one embodiment, signals transmitted by service provider wireless circuit 118 to customer site wireless circuit 116 include any suitable control signals, such as signals for closing valves coupled to meter reading control circuit 120.

Service provider wireless circuit 118 transmits signals to the service provider at 152. Control circuit 144 transmits signals that represent resource usage data including a compiled meter reading value to the service provider at 152. The compiled meter reading value can be any suitable compiled meter reading value. In one embodiment, control circuit 144 transmits signals that represent the compiled meter reading value transmitted periodically by utility meter 104. In one embodiment, control circuit 144 transmits signals that represent the compiled meter reading value compiled by meter reading control circuit 120 and transmitted periodically. In one embodiment, control circuit 144 transmits signals that represent the compiled meter reading value compiled by dual channel control circuit 128 and transmitted periodically. In one embodiment, control circuit 144 transmits signals that represent a meter reading value compiled by control circuit 136 and transmitted periodically.

In one embodiment, control circuit 144 communicates bi-directionally with the service provider. The service provider transmits a meter reading request signal to control circuit 144. Control circuit 144 transmits resource usage data including a compiled meter reading value to the service provider at 152 in response to the request. In one embodiment, the compiled meter reading value is the value compiled by utility meter 104 and retrieved via a meter reading request signal. In one embodiment, the compiled meter reading value is the value compiled by meter reading control circuit 120 and retrieved via a meter reading request signal. In one embodiment, the compiled meter reading value is the value compiled by dual channel control circuit 128 and retrieved via a meter reading request signal. In one embodiment, the compiled meter reading value is the value compiled by control circuit 136 and retrieved via a meter reading request signal. In one embodiment, signals transmitted by the service provider to service provider wireless circuit 118 include any suitable control signals, such as signals for closing valves coupled to meter reading control circuit 120.

Control circuits 120, 128, 136 and 144 can be any suitable control circuitry, such as microprocessors, microcontrollers or application specific integrated circuit control circuits. Also, control circuits 120, 128, 136 and 144 include suitable memory and programs for providing the requisite functions.

In one embodiment, service provider wireless circuit 118 is located on a mobile platform, such as a service provider vehicle or a hand held device. As the mobile platform travels past customer site wireless circuit 116, service provider wireless circuit 118 transmits a wireless meter reading request. Customer site wireless circuit 116 receives the request and provides resource usage data.

In one embodiment, service provider wireless circuit 118 is located on a stationary or non-mobile platform, such as a tower. In one embodiment, the service provider wireless circuit 118 that is located on the non-mobile platform transmits a wireless meter reading request. Customer site wireless circuit 116 receives the request and provides resource usage data. In one embodiment, meter 104 or one of the control circuits 120, 128, or 136 is programmed to periodically provide resource usage data to the service provider wireless circuit 118 that is located on the non-mobile platform. The compiled meter reading value can be periodically obtained from any suitable source, such as meter 104 or one of the control circuits 120, 128, or 136 via a meter reading request signal.

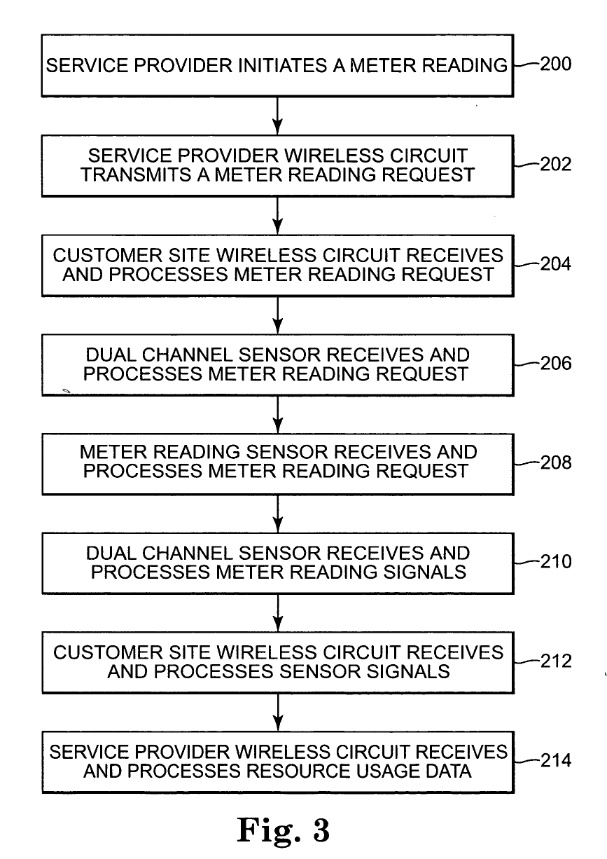

FIG. 3 is a flow chart diagram illustrating the operation of one embodiment of utility meter reading system 108. In this embodiment, service provider wireless circuit 118, customer site wireless circuit 116, dual channel sensor 114, and meter reading sensor 112 communicate bi-directionally. The meter reading value is compiled by meter reading sensor 112.

At 200, the service provider initiates a meter reading and a meter reading request signal is received by control circuit 144. In response, control circuit 144 provides a meter reading request signal to wireless circuit 146, which transmits a wireless meter reading request signal via antenna 148 to customer site wireless circuit 116 at 202. Wireless circuit 138 receives the meter reading request signal via antenna 142 at 204 and transmits a corresponding meter reading request signal to control circuit 136. In response to the meter reading request signal, control circuit 136 provides a meter reading request signal to dual channel sensor 114.

At 206, dual channel control circuit 128 receives the meter reading request signal and provides an electrical meter reading request signal to dual channel sensor transducer 130. Dual channel sensor transducer 130 converts the electrical meter reading request signal to a sonic meter reading request signal that is transmitted to meter reading sensor 112 via customer site resource distribution channel 106. At 208, meter reading sensor transducer 122 receives the sonic meter reading request signal and transmits a corresponding electrical meter reading request signal to meter reading control circuit 120. Meter reading control circuit 120 responds to the request by transmitting a compiled meter reading value to meter reading sensor transducer 122. The compiled meter reading value is compiled by control circuit 120. Meter reading sensor transducer 122 transmits sonic meter reading signals including the compiled meter reading value to dual channel sensor 114.

At 210, dual channel sensor transducer 130 receives the sonic meter reading signals from meter reading sensor transducer 122 via customer site resource distribution channel 106. Dual channel sensor transducer 130 converts the received sonic meter reading signals to electrical signals that are transmitted to dual channel control circuit 128. Dual channel control circuit 128 receives the electrical signals from dual channel sensor transducer 130 and provides sensor signals including the compiled meter reading value to customer site wireless circuit 116.

At 212, control circuit 136 receives the sensor signals including the compiled meter reading value. In response, control circuit 136 processes the sensor signals and transmits signals to wireless circuit 138, which receives the signals and transmits corresponding wireless resource usage data signals via antenna 142. The transmitted wireless resource usage data signals include the compiled meter reading value.

At 214, service provider wireless circuit 118 receives the wireless resource usage data signals including the compiled meter reading value. Wireless circuit 146 receives the wireless resource usage data signals via antenna 148 and transmits corresponding signals to control circuit 144. Control circuit 144 transmits the resource usage data including the compiled meter reading value to the service provider.

In other embodiments including bi-directional communications, the compiled meter reading value is obtained from another component, such as customer site wireless circuit 116, dual channel sensor 114, and utility meter 104. The meter reading request is transmitted to the appropriate component and the compiled meter reading value is provided.

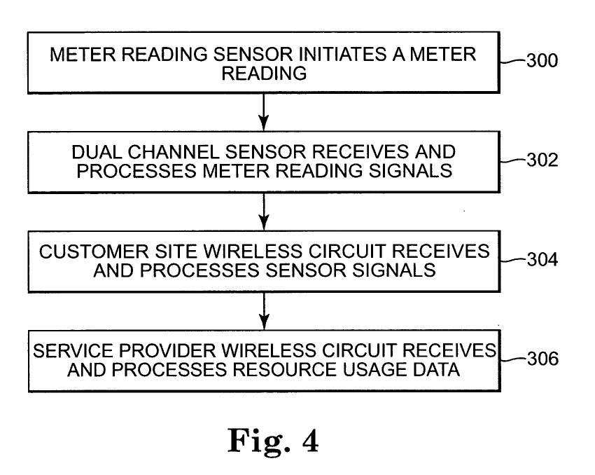

FIG. 4 is a flow chart diagram illustrating the operation of another embodiment of utility meter reading system 108. In this embodiment, a meter reading request signal is not used to initiate a meter reading. Instead, meter reading sensor 112 compiles the meter reading value and periodically initiates a meter reading.

At 300, meter reading sensor 112 initiates a meter reading. Meter reading control circuit 120 transmits electrical signals including the compiled meter reading value to meter reading sensor transducer 122. The electrical signals are received by meter reading sensor transducer 122 and converted to sonic meter reading signals that include the compiled meter reading value. The sonic meter reading signals are transmitted to dual channel sensor 114 via customer site resource distribution channel 106.

At 302, dual channel sensor transducer 130 receives the sonic meter reading signals and converts the received sonic signals to electrical signals that are transmitted to dual channel control circuit 128. Dual channel control circuit 128 receives the electrical signals from dual channel sensor transducer 130 and provides sensor signals that include the compiled meter reading value to customer site wireless circuit 116.

At 304, control circuit 136 receives the sensor signals that include the compiled meter reading value and transmits corresponding signals to wireless circuit 138. Wireless circuit 138 receives the corresponding signals and transmits wireless resource usage data signals that include the compiled meter reading value via antenna 142. At 306, the wireless resource usage data signals are received by service provider wireless circuit 118. Wireless circuit 146 receives the wireless resource usage data signals via antenna 148 and transmits corresponding signals to control circuit 144. Control circuit 144 transmits the resource usage data including the compiled meter reading value to the service provider.

In other embodiments, a periodic meter reading can be initiated by any suitable component, such as service provider wireless circuit 118, customer site wireless circuit 116, dual channel sensor 114, and utility meter 104. Also, the compiled meter reading can be obtained from any suitable component, such as customer site wireless circuit 116, dual channel sensor 114, meter reading sensor 112 and utility meter 104, by providing a periodic meter reading request to the component that provides the compiled meter reading.

Although specific embodiments have been illustrated and described herein, it will be appreciated by those of ordinary skill in the art that a variety of alternate and/or equivalent implementations may be substituted for the specific embodiments shown and described without departing from the scope of the present invention. This application is intended to cover any adaptations or variations of the specific embodiments discussed herein. Therefore, it is intended that this invention be limited only by the claims and the equivalents thereof.

What is claimed is:

1. A meter reading system comprising:
a first sensor configured to obtain meter data from a first utility meter and transmit first signals of a first signal type on a first channel;
a second sensor configured to receive the first signals on the first channel and transmit second signals of a second signal type on a second channel;
a first circuit configured to receive the second signals on the second channel and transmit third signals via radio frequency signals to a service provider.

2. The meter reading system of claim 1, comprising:
a third sensor configured to obtain meter data from a second utility meter and transmit fourth signals of the first signal type on a third channel;
a fourth sensor configured to receive the fourth signals on the third channel and transmit fifth signals of the second signal type on a fourth channel; and
a second circuit configured to receive the fifth signals on the fourth channel and transmit sixth signals via radio frequency signals to the service provider.

3. The meter reading system of claim 2, comprising a third circuit configured to receive the third signals and the sixth signals, wherein the third circuit is located on one of a mobile platform and a stationary platform.

4. The meter reading system of claim 1, wherein the first channel comprises at least one of a conduit and a pipe and the third channel comprises at least one of a conduit and a pipe.

5. The meter reading system of claim 1, wherein the first signal type comprises sonic signals in at least one of the hearing frequency range and the ultrasonic frequency range.

6. The meter reading system of claim 1, wherein the first utility meter comprises one of a gas meter, an electric meter and a water meter and the second utility meter comprises one of a gas meter, an electric meter and a water meter.

7. A meter reading system comprising:
a first sensor configured to obtain meter data from a utility meter and provide sonic signals on a first channel based on the meter data;
a second sensor configured to receive the sonic signals on the first channel and provide electrical signals on a second channel based on the sonic signals; and
a first circuit configured to receive the electrical signals on the second channel and transmit resource usage data via radio frequency signals to a service provider based on the electrical signals.

8. The meter reading system of claim 7, wherein the first circuit comprises:
a radio frequency transceiver; and
a control circuit configured to obtain the resource usage data from the electrical signals and transmit the resource usage data via the radio frequency transceiver.

9. The meter reading system of claim 7, wherein periodic transmission of the resource usage data from the first circuit to the service provider is initiated by one of the first sensor, the second sensor, the first circuit, and the utility meter.

10. The meter reading system of claim 7, comprising:
a second circuit configured to receive the resource usage data and provide the resource usage data to the service provider, wherein the first circuit includes a first radio frequency transceiver and the second circuit includes a second radio frequency transceiver, wherein the first circuit and the second circuit are configured to communicate bi-directionally via the first radio frequency transceiver and the second radio frequency transceiver.

11. The meter reading system of claim 10, wherein the second circuit transmits a request to the first circuit and the first circuit transmits the resource usage data to the second circuit in response to the request.

12. The meter reading system of claim 7, wherein the first circuit is configured to communicate bi-directionally on the second channel, the second sensor is configured to communicate bi-directionally on the first channel and on the second channel, and the first sensor is configured to communicate bi-directionally on the first channel.

13. The meter reading system of claim 7, wherein the first sensor comprises a first transducer and the second sensor comprises a second transducer, wherein the first transducer and the second transducer are configured to communicate on the first channel via the sonic signals in at least one of the hearing frequency range and the ultrasonic frequency range.

14. The meter reading system of claim 7, wherein the first sensor and the second sensor are configured to communicate on the first channel via at least one of amplitude modulated signals and frequency modulated signals.

15. The meter reading system of claim 7, wherein the first sensor comprises:
a control circuit configured to compile meter readings from the meter data and provide the compiled meter readings in the first signals.

16. The meter reading system of claim 7, wherein the second sensor comprises:
a control circuit configured to compile meter readings from the first signals and provide the compiled meter readings in the second signals.

17. A method for reading utility meters comprising:
receiving utility meter data at a first sensor situated in a utility meter pit;
transmitting sonic signals on a first channel from the first sensor based on the utility meter data;
receiving the sonic signals on the first channel at a second sensor situated outside the utility meter pit;
transmitting second signals on a second channel from the second sensor based on the sonic signals;
receiving the second signals on the second channel at a first circuit situated outside the utility meter pit; and
transmitting resource usage data via radio frequency signals from the first circuit to a service provider based on the second signals.

18. The method of claim 17, comprising:
transmitting the resource usage data at periodic intervals from the first circuit to the service provider.

19. The method of claim 17, comprising:
transmitting a request from a second circuit to the first circuit via radio frequency signals;
transmitting the resource usage data from the first circuit to the second circuit via radio frequency signals in response to the request;
receiving the resource usage data at the second circuit; and
supplying the resource usage data from the second circuit to the service provider.

20. The method of claim 17, wherein transmitting sonic signals comprises:
transmitting the sonic signals in at least one of the hearing frequency range and the ultrasonic frequency range; and
transmitting the sonic signals as at least one of amplitude modulated signals and frequency modulated signals.
